(19) United States
(12) Patent Application Publication
(10) Pub. No.: US 2026/0014468 A1
(43) Pub. Date: Jan. 15, 2026

(54) REINFORCEMENT-LEARNING-BASED NPC BATTLE DECISION-MAKING METHOD AND RELATED PRODUCT

(71) Applicant: Tencent Technology (Shenzhen) Company Limited, Shenzhen (CN)

(72) Inventors: Jingwen YANG, Shenzhen (CN); Nan HU, Shenzhen (CN); Yichi XIAO, Shenzhen (CN); Hao ZHOU, Shenzhen (CN)

(21) Appl. No.: 19/334,656

(22) Filed: Sep. 19, 2025

Related U.S. Application Data
(63) Continuation of application No. PCT/CN2024/107801, filed on Jul. 26, 2024.

(30) Foreign Application Priority Data
Sep. 26, 2023 (CN) 202311250926.1

(51) Int. Cl. A63F 13/55; G06N 3/092

(52) U.S. Cl. CPC A63F 13/55; G06N 3/092; A63F 2300/6027

(57) ABSTRACT

This application discloses a reinforcement-learning-based non-player character (NPC) battle decision-making method and a related product. The method includes: obtaining current state information, current relative pose information, and historical battle state information of a target NPC and its opponent; processing the current state information and the current relative pose information, through a long short-term memory network, to obtain a first processing result; and making a decision about a battle policy that is to be taken by the target NPC at a next moment based on the first processing result, context information of skill release of the target NPC, a skill set of the target NPC, and a reward item of a reinforcement learning model. As a result, an NPC battle decision is obtained through the reinforcement learning model, without establishing a complex behavior tree, thereby saving labor costs.

### CROSS-REFERENCE TO RELATED APPLICATIONS

This application is a continuation application of PCT Patent Application No. PCT/CN2024/107801, entitled “REINFORCEMENT-LEARNING-BASED NPC BATTLE DECISION-MAKING METHOD AND RELATED PRODUCT” filed on Jul. 26, 2024, which claims priority to Chinese Patent Application No. 2023112509261, entitled “REINFORCEMENT-LEARNING-BASED NPC BATTLE DECISION-MAKING METHOD AND RELATED PRODUCT” and filed with the China National Intellectual Property Administration on Sep. 26, 2023, both of which are incorporated by reference in their entirety.

### FIELD OF THE TECHNOLOGY

This application relates to the field of artificial intelligence technologies, and in particular to, a reinforcement-learning-based non-player character (NPC) battle decision-making method and a related product.

### BACKGROUND OF THE DISCLOSURE

Nowadays, with continuous development of science and technology, people have more and more entertainment ways, and games are one of the entertainment ways that most people choose. NPC is an abbreviation of non-player character. It is a character type in a game, meaning a non-player character, i.e. a game character that is not controlled by a real player in the game. The NPC can provide various services and experiences in the game, to enhance the vividness and interactivity of the game. The NPC is very important in the game. The NPC can push the plot of the game, post a task for a player character, conduct a transaction with a player character, and further help a player character fight.

A combat NPC needs to face a variety of scenes and enemies in a game world, and fights against various enemies in various scenes. The combat NPC needs to make different battle decisions in face of different enemies in different scenes. For example, when there are ten low-level enemies in a plain game scene, the combat NPC can make battle decision A. When there is an elite-level enemy in a volcano scene, the combat NPC makes battle decision B. In a related art, a battle decision of the combat NPC is usually determined in a manner of a behavior tree. The behavior tree is a tree with a clear node hierarchy, and controls a series of battle policies of the combat NPC.

However, using the behavior tree to determine the battle decision of the combat NPC in an open virtual scene often needs to consume a lot of labor costs. Therefore, how to reduce the labor costs configured for determining the battle decision of the combat NPC becomes a technical problem urgently needing to be solved.

### SUMMARY

Embodiments of this application provide a reinforcement-learning-based NPC battle decision-making method and a related product, to solve a problem in the related art that a lot of labor costs are consumed to determine an NPC battle decision.

A first aspect of this application provides a reinforcement-learning-based NPC battle decision-making method performed by a computer device, the method including:
obtaining current state information of a target NPC and an opponent of the target NPC, current relative pose information of the target NPC and the opponent in a virtual scene, and historical battle state information of the target NPC and the opponent;
performing feature extraction and concatenation on the current state information of the target NPC and the opponent and the current relative pose information of the target NPC and the opponent, to obtain a concatenated feature;
processing the concatenated feature and the historical battle state information through a long short-term memory network, to obtain a first processing result;
applying the first processing result, context information of the skill release of the target NPC and a skill set of the target NPC to a reinforcement learning model to obtain a reward value of a reward item based on reduction of a combat ability of the opponent; and
making a decision about a battle policy that is to be taken by the target NPC at a next moment based on the reward value of the reward item.

A second aspect of this application provides a reinforcement-learning-based NPC battle decision-making device, the device including a processor and a memory,
the memory being configured to: store a computer program and transmit the computer program to the processor; and
the processor being configured to perform the operations of the reinforcement-learning-based NPC battle decision-making method provided in the first aspect.

A third aspect of this application provides a non-transitory computer-readable storage medium, configured to store a computer program, the computer program, when executed by a reinforcement-learning-based NPC battle decision-making device, implementing the operations of the reinforcement-learning-based NPC battle decision-making method provided in the first aspect.

In view of the foregoing technical solution, embodiments of this application have the following advantages:

In the technical solutions of this application, feature extraction and concatenation are performed by using the obtained current state information of the target NPC in the virtual scene, the obtained current state information of the opponent, and the obtained current relative pose information, to obtain the concatenated feature. The concatenated feature and the historical battle state information are processed through the long short-term memory network, to obtain the first processing result outputted by the long short-term memory network. The decision about the battle policy that is to be taken by the target NPC at the next moment is made in the manner of reinforcement learning based on the first processing result, the context information of the skill release of the target NPC, the skill set of the target NPC, and the reward item of the reinforcement learning. Since a concatenated feature is obtained by using information at a moment, the concatenated feature can well represent battle state information at the moment. The battle state information at this moment and the historical battle state information are processed in the long short-term memory network, to obtain the first processing result. The first processing result is a result obtained by combining the battle state information at this moment and the battle state information at a historical moment. The first processing result combines the current battle state information with the historical battle state information. This is conductive to more accurately determining the battle policy of the target NPC at the next moment. The decision about the battle policy that is to be taken by the target NPC at the next moment is made based on the first processing result and related information in the manner of reinforcement learning. Battle decisions of the target NPC at the next moment in different scenes can be simply and efficiently determined after the related information is obtained and processing and reward item setting are performed. Compared with the related art, a large quantity of behavior trees with complex structures do not need to be established, thereby saving a lot of manpower costs and improving processing efficiency and decision-making precision.

### BRIEF DESCRIPTION OF THE DRAWINGS

FIG. 1 is a schematic diagram of a behavior tree of a combat NPC;

FIG. 2 is a diagram of a scene architecture of a reinforcement-learning-based NPC battle decision-making method provided in an embodiment of this application;

FIG. 3 is a flowchart of a reinforcement-learning-based NPC battle decision-making method provided in an embodiment of this application;

FIG. 4 is a schematic diagram of an application scene of a reinforcement-learning-based NPC battle decision-making method provided in an embodiment of this application;

FIG. 5 is a schematic structural diagram of a reinforcement-learning-based NPC battle decision-making method provided in an embodiment of this application;

FIG. 6 is a diagram of a network structure of a reinforcement-learning-based NPC battle decision-making method provided in an embodiment of this application;

FIG. 7 is a schematic structural diagram of a reinforcement-learning-based NPC battle decision-making apparatus provided in an embodiment of this application;

FIG. 8 is a schematic structural diagram of a server in an embodiment of the present disclosure; and

FIG. 9 is a schematic structural diagram of a terminal device in an embodiment of the present disclosure.

### DESCRIPTION OF EMBODIMENTS

As mentioned above, a behavior tree is a tree with a clear node hierarchy, and a series of battle policies of a combat NPC may be controlled by using the behavior tree.

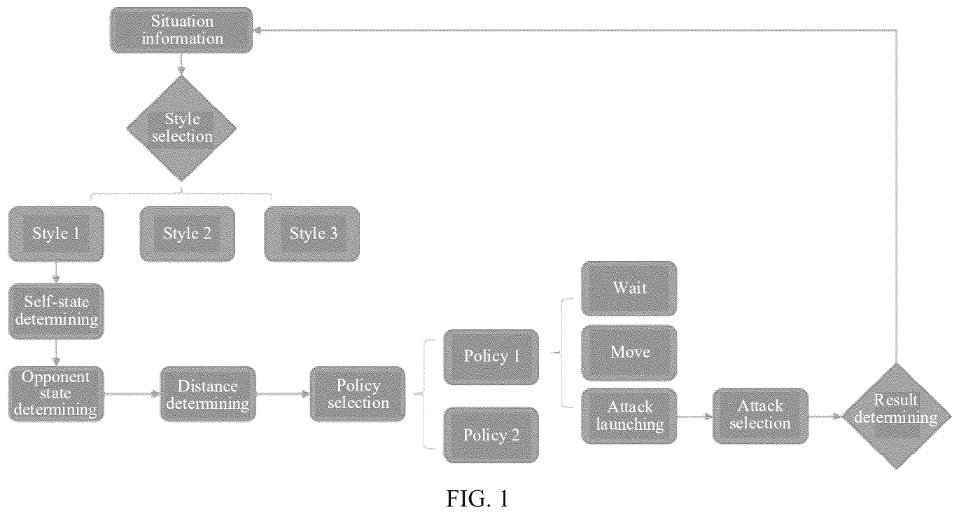

FIG. 1 is a schematic diagram of a behavior tree of a combat NPC. Situation information may include a combat scene and an enemy. A battle style of a combat NPC is selected through a style selection node. For example, style 1 may be an aggressive battle style that exchanges injury for injury; style 2 may be a balanced battle style; and style 3 may be a conservative battle style that preferentially ensures a state of the combat NPC. After the style is selected, a policy selection node is after a self-state determining node, an opponent state determining node, and a distance determining node. A policy 1 node or a policy 2 node is selected through the policy selection node. A waiting node, a movement node, and an attack launching node exist under the policy 1 node. A skill node, i.e. an attack selection node, that can be released by the combat NPC exists under the attack launching node. After a skill selected by the attack selection node is executed, an execution result is returned to a situation information node.

The situation information in the schematic diagram of the behavior tree of the combat NPC shown in FIG. 1 is particular situation information. In a possible implementation, the situation information includes fighting against three low-level enemies in a forest game scene, and battle decisions made by the behavior tree are all for a situation of fighting against the three low-level enemies in the forest game scene. If there is a situation of fighting against five fish enemies in a deep sea game scene, the behavior tree of the combat NPC shown in FIG. 1 cannot be used, and a behavior tree of fighting against the five fish enemies in the corresponding deep sea game scene needs to be established to determine a battle policy of the combat NPC in this scene.

There may be a very large quantity of combat situations in a game. In the related art, for each combat situation, situation information needs to be used to establish a behavior tree corresponding to the situation information, and then a battle policy of a combat NPC is determined by using the behavior tree. Different NPCs correspond to different behavior trees of the same situation information. In a possible implementation, under the same situation information, NPC1 may have only two styles, but NPC2 may have five styles. This means that under the same situation information, behavior trees of NPC1 and NPC2 are completely different. As a result, when battle policies of NPCs are determined by using behavior trees, a very large quantity of behavior trees need to be established. This further causes a problem of high labor costs.

In view of the above problem, this application provides a reinforcement-learning-based NPC battle decision-making method and a related product, to determine a battle decision of an NPC, with low labor costs.

An executing entity of the reinforcement-learning-based NPC battle decision-making method provided in this embodiment of this application may be a computer device. The computer device may include a terminal device or a server. For example, information in a virtual scene is obtained from the terminal device. As an example, the terminal device may specifically include, but is not limited to, a mobile phone, a desktop computer, a tablet computer, a notebook computer, a palmtop computer, an in-vehicle terminal, an aircraft, and the like. An executing entity of the reinforcement-learning-based NPC battle decision-making method provided in this embodiment of this application may alternatively be a server. To be specific, a concatenated feature and historical battle state information may be processed on the server through a long short-term memory network, to obtain a first processing result outputted by the long short-term memory network. The reinforcement-learning-based NPC battle decision-making method provided in this embodiment of this application may alternatively be synergistically executed by a terminal device and a server. Therefore, the executing entity for performing the technical solutions of this application is not limited in this embodiment of this application.

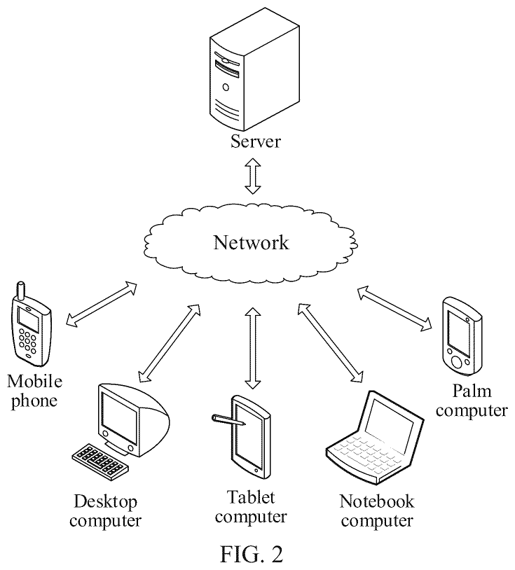

FIG. 2 exemplarily shows a diagram of a scene architecture of a reinforcement-learning-based NPC battle decision-making method. A server and terminal devices in various forms are included in the figure. The server shown in FIG. 2 may be an independent physical server, a server cluster including a plurality of physical servers, or a distributed system. In addition, the server may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

FIG. 3 is a flowchart of a reinforcement-learning-based NPC battle decision-making method provided in an embodiment of this application. The method may be performed by a computer device. In this embodiment, an example in which the computer device is a terminal device is used for description. The reinforcement-learning-based NPC battle decision-making method shown in FIG. 3 includes:

S301: Obtain current state information of a target NPC in a virtual scene, current state information of an opponent of the target NPC, current relative pose information of the target NPC and the opponent, and historical battle state information of the target NPC and the opponent.

The virtual scene may be a game scene. In a possible implementation, the virtual scene may be an open virtual scene. The open virtual scene is a virtual scene with an extremely high degree of freedom, for example, an open game world.

The terminal device obtains the current state information of the target NPC, the current state information of the opponent of the target NPC, the current relative pose information of the target NPC and the opponent, and the historical battle state information of the target NPC and the opponent. The target NPC is an NPC in the virtual scene. In a possible implementation, the target NPC may be a combat NPC in the open virtual scene.

The current state information of the target NPC that is obtained by the terminal device includes context information of skill release of the target NPC and a skill set of the target NPC. In a possible implementation, the target NPC is releasing skill A that needs to be continuously released. Skill A requires release time of 20 seconds. At a moment when the terminal device obtains the current state information of the target NPC, the target NPC has released skill A for five seconds, so that the current state information of the target NPC includes information that skill A has been released for five seconds. The target NPC may use ten skills: skill A, skill B, . . . , and skill J, and the terminal device obtains the skill set of the target NPC that is formed by the ten skills. The context information of the released skill may be a carry-over effect of an unfinished skill in the skill that has been released by the target NPC. In a possible implementation, the target NPC releases skill A at a moment, and an effect of skill A is continuously damaging the opponent of the target NPC within ten seconds. At another moment that is five seconds after this moment, the context information of the skill release may be that skill A has continuously causing a five-second damage to the opponent of the target NPC, skill A can still continuously cause another five-second damage to the opponent of the target NPC, and other information.

In a possible implementation, coordinates of the target NPC in the virtual scene at a current moment are (100, 300, 200), a front face of the target NPC faces a positive direction of an x-axis. The above information may be used as the current state information of the target NPC. The target NPC has health points of 300, Attack of 50, Defense of 30, and a critical chance of 50%. The above information may be used as the current state information of the target NPC, too. The current state information of the target NPC may further include current combat ability attribute information of a teammate belonging to a same camp as the target NPC, movement information, context information of a released skill of the teammate, and a skill set of the teammate.

Information of an object that fights against the target NPC at a moment is the current state information of the opponent of the target NPC. In a possible implementation, coordinates of an object that fights against the target NPC are (105, 302, 201). A front face of the object that fights against the target NPC faces a negative half-axis direction of a y-axis. The above information may be used as the current state information of the opponent of the target NPC. The opponent of the target NPC has health points of 5000, Attack of 100, Defense of 10, and a critical chance of 10%. The above information may be used as the current state information of the opponent of the target NPC, too.

The current relative pose information of the target NPC and the opponent is configured for representing relative poses of the target NPC and the opponent, and relative positions of the target NPC and the opponent. In a possible implementation, coordinates of the target NPC are (100, 300, 200), and coordinates of an object that fights against the target NPC are (105, 302, 201). Current relative positions of the target NPC and the opponent may be determined by using the coordinates of the target NPC and the coordinates of the object that fights against the target NPC. A front face of the target NPC faces the opponent, and a front face of the opponent faces a negative half-axis direction of the y-axis. Relative orientation information of the front face of the target NPC and the front face of the opponent may be used as relative poses.

The historical battle state information of the target NPC and the opponent means historical battle states of the target NPC and the opponent at a moment before a current moment.

S302: Perform feature extraction and concatenation based on the current state information of the target NPC, the current state information of the opponent, and the current relative pose information, to obtain a concatenated feature;

The terminal device performs the feature extraction on the current state information of the target NPC, the current state information of the opponent, and the current relative pose information, and a feature that can be identified by a neural network is obtained after the feature extraction. During the feature extraction, different feature types may have different processing methods. In a possible implementation, the current state information of the target NPC is data of a discrete category, and may be processed by using an encoding mode such as one hot encoding. The current relative pose information is a continuous feature, and may be processed by encoding such as fully connected network encoding. The terminal device obtains a plurality of features through the feature extraction, and concatenates the plurality of features to obtain the concatenated feature. In a possible implementation, the concatenated feature may be a long vector.

S303: Process the concatenated feature and the historical battle state information through a long short-term memory network, to obtain a first processing result outputted by the long short-term memory network.

The long short-term memory (LSTM) network combines a short-term memory with a long-term memory through gate control, and the long short-term memory network can better process problems of long-term information storage and short-term input jump.

The concatenated feature is configured for representing a feature of a moment. The historical battle state information is battle state information before this moment. The long short-term memory network processes the concatenated feature and the historical battle state information, to obtain the first processing result outputted by the long short-term memory network. Through the LSTM network, the concatenated feature and the historical battle state information can be better fused from the perspective of time sequence, and a time sequence relationship between the concatenated feature and the historical battle state information is established. The information can be embodied in the first processing result, so as to provide a basis for a subsequent policy decision-making.

S304: Make, in a manner of reinforcement learning based on the first processing result, the context information of the skill release of the target NPC, the skill set of the target NPC, and a reward value of a reward item of the reinforcement learning, a decision about a battle policy that is to be taken by the target NPC at a next moment.

An action executed by the target NPC in a virtual environment may be obtained through the reinforcement learning. Each action executed by the target NPC has a corresponding reward item, and the reward item is a result that the target NPC is expected to achieve. Generally, for the target NPC, reduction a combat ability of the opponent is a result that the target NPC is expected to achieve. Therefore, reducing the combat ability of the opponent is generally used as the reward item. Based on the reduction of the combat ability of the opponent, the reward value of the reward item may be determined. Generally, greater reduction of the combat ability of the opponent indicates a larger corresponding reward value of the reward item.

In a possible implementation, the reward item may be a percentage of health points decrease of the opponent. For example, if the target NPC performs action 1, the health points of the opponent may be reduced by 2%. If the target NPC performs action 2, the health points of the opponent may be reduced by 5%. Both action 1 and action 2 have corresponding reward values. Since action 2 reduces the health points of the opponent by a larger percentage, the reward value of action 2 is greater than the reward value of action 1.

In another possible implementation, the reward item may consider both the percentage of health points decrease of the opponent and the percentage of health points decrease of the target NPC. For example, if the target NPC performs action 3, the health points of the opponent can be reduced by 2%, and the health points of the target NPC may be reduced by 5%. If the target NPC performs action 4, the health points of the opponent can be reduced by 5%, and the health points of the target NPC may be reduced by 20%. Both action 3 and action 4 have corresponding reward values. Although action 4 reduces the health points of the opponent by a larger percentage, action 4 also reduces the health points of the target NPC by a larger percentage. By considering action 3 and action 4 comprehensively, the reward value of action 3 may be generally greater than the reward value of action 4.

In still another possible implementation, the reward item may consider both the percentage of health points decrease of the opponent and the percentage of health points decrease of the target NPC, and a particular weight is set for the percentage of health points decrease percentage of the object and the percentage of health points decrease of the target NPC, to comprehensively obtain a final reward value.

In addition to directly reducing the percentage of health points decrease of the opponent, reducing the combat ability of the opponent may further reduce the current state information of the opponent. In a possible implementation, if the target NPC performs action 5, the Defense of the opponent may be reduced by 50%. If the target NPC performs action 6, the health points of the opponent may be reduced by 3%. Both action 5 and action 6 have corresponding reward values. By considering action 5 and action 6 comprehensively, the reward value of action 5 may be generally greater than the reward value of action 6.

In a possible implementation, the reward item may further consider time at which the opponent is defeated. If the target NPC performs action 7, it takes 30 seconds to defeat the opponent. If the target NPC performs action 8, it only takes 20 seconds to defeat the opponent. Both action 7 and action 8 have corresponding reward values. By considering action 7 and action 8 comprehensively, the reward value of action 8 may be greater than the reward value of action 7.

In another possible implementation, the reward item may further consider a distance between the target NPC and the opponent. When the target NPC performs action 9, the target NPC keeps a relatively long distance from the opponent. When the target NPC performs action 10, a distance between the target NPC and the opponent is very short. Both action 9 and action 10 have corresponding reward values. By considering action 9 and action 10 comprehensively, the reward value of action 10 may be greater than the reward value of action 9.

The reward item of the reinforcement learning may be determined according to an actual requirement. Generally, the reward item of the reinforcement learning may have a plurality of indexes, and each index has a corresponding weight. In a possible implementation, reward values of a plurality of reward items may be subjected to weighted summation to obtain the reward value. The terminal device makes, in the manner of reinforcement learning, the decision about the battle policy that is to be taken by the target NPC at the next moment.

In a possible implementation, the terminal device performs feature extraction on the context information of the skill release of the target NPC and the skill set of the target NPC, to obtain a plurality of skill features of the target NPC, the skill set including a name, an effect label, cooldown time, a release distance, and current availability of each skill of the target NPC. For example, the target NPC has two skills, skill A and skill B. For skill A, the skill name is recover; the effect label is recovering the health points of skill A by 10%; the cooldown time is 30 seconds; the release distance is 1; and the current availability is available. For skill B, the skill name is fireball; the effect label is reducing the health points of the opponent by 20 points; the cooldown time is two seconds; the release distance is 20; and the current availability is unavailable. The skill set includes the plurality of features corresponding to skill A and the plurality of features corresponding to skill B. The features of skill A and skill B are concatenated to obtain the skill feature concatenation result. The decision about the battle policy that is to be taken by the target NPC at the next moment is made in the manner of reinforcement learning based on the first processing result, the skill feature concatenation result, and the reward item of the reinforcement learning.

As can be seen, considering that the first processing result reflects overall features of the target NPC and the opponent in a global time sequence, and the skills of the target NPC skill is one of key factors for making a policy decision for the target NPC, to improve a proportion of the features related to the skills of the target NPC skill in subsequent decisions, the feature concatenation is first performed on the context information of the skill release of the target NPC and the skill set of the target NPC, and then the obtained skill feature concatenation result and the first processing result are configured for the reinforcement learning, so that in the reinforcement learning, clear target NPC skill information having a large proportion can be obtained, and finally, accuracy of the battle policy that is to be taken by the target NPC at the next moment through the reinforcement learning is improved.

A first probability distribution, a second probability distribution, and a third probability distribution of the target NPC at the next moment are predicted based on the first processing result, the skill feature concatenation result, and a reward value of a reward item that is obtained by a battle policy taken at a previous moment. The first probability distribution is a probability distribution about a released skill. In a possible implementation, the target NPC has two skills: skill A and skill B. Descriptions of skill A and skill B in this paragraph are the same as the descriptions in the previous paragraph. Since the current availability of skill A is available, and the current availability of skill B is unavailable, a probability of releasing skill A in the first probability distribution is 100%, and a probability of releasing skill B is 0%. In another possible implementation, in addition to skill A and skill B, the target NPC masters skill C. For skill C, the skill name is freeze; the effect label is reducing a movement speed of the opponent to 0; the cooldown time is 20 seconds; and the release distance is 20; and the current availability is available. The terminal device may predict, based on the first processing result and the skill feature concatenation result, the probability distributions of releasing the three skills by the target NPC at the next moment.

The second probability distribution is a probability distribution about a movement direction, and the third probability distribution is a probability distribution about a movement distance. In a possible implementation, the target NPC masters skill D. The release distance of the skill D is 5, and a distance, displayed in the first processing result, between the target NPC and the opponent that is 10. To release skill D, the target NPC needs to shorten the distance from the opponent by movement. The target NPC may move towards the opponent along a straight line, or the target NPC may move towards the opponent based on an arc path. The second probability distribution is the probability distribution about the movement direction. The target NPC may move towards the opponent along the straight line. The target NPC may move towards the opponent along the straight line by 8, or the target NPC may move towards the opponent along the straight line by 5. The third probability distribution is the probability distribution about the movement distance. In another possible implementation, the target NPC masters skill E. An effect of skill E is recovering the health points of the target NPC by 50 points. The target NPC does not need to move or turn when releasing skill E. In this case, the target NPC may be directly controlled to release skill E, without any movement or turning. In still another possible implementation, the target NPC masters skill F. An effect of skill F is attacking an opposing character within a range of 10 centered on the target NPC. The target NPC does not need to move or turn when releasing skill F. In this case, the target NPC may be directly controlled to release skill F, without any movement or turning.

In a possible implementation, the second probability distribution includes a macroscale movement direction probability distribution and a microscale movement direction probability distribution. Microscale movement means a tiny movement performed in the virtual environment. For example, the target NPC moves to the left by three pixels. Macroscale movement means that the target NPC moves within a large range in the virtual environment. For example, the target NPC moves from coordinates (0, 0, 0) to coordinates (0, 0, 1000) in the virtual environment.

The third probability distribution includes a macroscale movement distance probability distribution and a microscale movement distance probability distribution. A target macroscale movement distance is determined based on a highest value in the macroscale movement distance probability distribution, and a target microscale movement distance is determined based on a highest value in the microscale movement distance probability distribution. In a possible implementation, a macroscale movement distance may be a distance of movement from a coordinate in an open virtual scene to another coordinate, and a microscale movement distance may be a leg lifting height, an extent of waving a hand, or the like.

A target skill is determined based on a highest value in the first probability distribution; a target direction is determined based on a highest value in the second probability distribution; and a target distance is determined based on a highest value in the third probability distribution. In a possible implementation, skill C is the highest value in the first probability distribution. The movement to the opponent along the straight line is the highest value in the second probability distribution. The movement of 5 is the highest value in the third probability distribution. Based on the above information, that the target NPC releases the target skill at the next moment and moves in the target direction by the target distance may be simulated. To be specific, the target NPC releases skill C at the next moment, i.e. a second moment, and moves towards the opponent along the straight line by 5. After the target NPC releases skill C at the next moment and moves towards the opponent along the straight line by 5, a reward value may be obtained. Based on the action at the second moment, an action performed by the target NPC at a third moment that is after the second moment may be obtained, and a reward value corresponding to the action performed at the third moment may be obtained. For the purpose of maximizing an obtained continuously cumulative value of the reward item, a decision about a battle policy that is to be taken by the target NPC at a next moment is made based on the continuously cumulative value of the reward item.

According to the method provided by this application, the concatenated feature and the historical battle state information are processed through the long short-term memory network, to obtain the first processing result outputted by the long short-term memory network. The method provided in this application not only considers a feature of a current moment, but also considers the historical battle state information, so that a more proper target NPC action can be obtained when the first processing result is used to perform the reinforcement learning. This application makes, in the manner of reinforcement learning, the decision about the battle policy that is to be taken by the target NPC at the next moment. The battle policy that is to be taken by the target NPC at the next moment may be obtained as long as information corresponding to a moment is used as an input of the reinforcement learning. Compared with the related art, this application does not need to establish a numerous of behavior trees with complex structures, thereby saving a lot of labor costs and also reducing time required for determining the baffle policy of the target NPC.

In a possible implementation, the current state information of the target NPC further includes current combat ability attribute information and movement information of the target NPC. The combat ability attribute information may be attribute information such as health points, Attack, Defense, a critical chance, and a movement speed of the target NPC, or may be a score for evaluating a combat ability attribute of the target NPC. For example, the current combat ability attribute information of the target NPC may include health points of 200, Attack of 10, Defense of 30, a critical chance of 10%, and a movement speed of 50. The current combat ability attribute information of the target NPC may further be a combat ability score obtained by comprehensively evaluating the above information, for example, a score of one health point is 5, a score of one point of the Attack is 10, a score of one point of the Defense is 3, a score of one point of the critical chance is 15, and a score of one point of the movement speed is 5. After the health points of 200, the Attack of 10, the Defense of 30, the critical chance of 10%, and the movement speed of 50 are scored, an obtained combat ability score is 1590. The 1590 score may be used as the current combat ability attribute information of the target NPC. The movement information is related information of movement of the target NPC in the virtual scene.

Current combat ability attribute information and movement information of the opponent that are included in the current state information of the opponent are similar to the current combat ability attribute information and movement information of the target NPC that are included in the current state information of the target NPC. Details are not described here again. The current state information of the opponent further includes context information of skill release of the opponent. For example, the opponent has skill X. It takes ten seconds to release skill X. At a moment, the opponent has already released skill X for three seconds, and this information is used as the context information of the skill release of the opponent.

The current relative pose information includes relative positions and relative orientations of the opponent and the target NPC.

The terminal device respectively performs the feature extraction on the current state information of the target NPC, the current state information of the opponent, and the current relative pose information, to obtain a current state feature of the target NPC, a current state feature of the opponent, and current relative pose features of the target NPC and the opponent. The terminal device concatenates a plurality of features included in the current state feature of the target NPC, to obtain a first concatenation result; concatenates a plurality of features included in the current state feature of the opponent, to obtain a second concatenation result; and concatenates a plurality of features included in the current relative pose feature, to obtain a third concatenation result. The concatenation may be performed based on a preset feature sequence. For example, when the terminal device concatenates the plurality of features included in the current state feature of the target NPC, the preset feature sequence stipulates that the concatenation is performed based on a sequence of a health points feature, an Attack feature, a Defense feature, a critical chance feature, a movement speed feature, and a movement information feature. A sequence of the features in the finally obtained first concatenation result is kept consistent with the preset feature sequence.

The terminal device respectively extracts the features in the first concatenation result, the second concatenation result, and the third concatenation result by using a first deep neural network, a second deep neural network, and a third deep neural network, to obtain a first extraction result, a second extraction result, and a third extraction result. In a possible implementation, the first deep neural network, the second deep neural network, and the third deep neural network may use deep-learning neural networks (DNNs).

The terminal device concatenates the first extraction result, the second extraction result, and the third extraction result, to obtain the concatenated feature.

In the method provided in this application, feature extraction and concatenation are respectively performed on the current state information of the target NPC, the current state information of the opponent, and the current relative pose information. In this application, considering a difference between the target NPC and the opponent, the current state information of the target NPC and the current state information of the opponent are not concatenated together after being extracted, but are separately processed. By separately processing the current state information of the target NPC and the current state information of the opponent, a difference between the target NPC and the opponent can be considered to a large extent, thereby finally improving the accuracy of the battle policy that is to be taken by the target NPC at the next moment through the reinforcement learning.

In a possible implementation, the terminal device may further obtain global environment information of the target NPC in the virtual scene, the global environment information including time information, a quantity of opponents, and environment warning perception information. The environment warning perception information includes a warning range before the opponent releases a skill and a sustained effect after the opponent releases the skill. For example, the opponent releases a flame spitting skill at a moment. An impact range of flame spitting is a sectoral range towards which the opponent faces, and the sectoral range may be used as the warning range before the opponent releases the skill. After the opponent releases the flame spitting skill, a flame lasting for five seconds is formed within the sectoral range, and the flame that is formed within the sectoral range and lasts for five seconds may be used as the sustained effect after the opponent releases the skill.

The terminal device may concatenate the global environment information, the first feature extraction result, the second feature extraction result, and the third feature extraction result, to obtain the concatenated feature.

In the method provided in this application, the impact of the global environment information on the battle decision of the target NPC is considered, the obtained global environment information is concatenated with the first feature extraction result corresponding to the current state information of the target NPC, the second feature extraction result corresponding to the current state information of the opponent, and the third feature extraction result corresponding to the current relative pose information. The battle decision of the target NPC can be obtained more accurately in the reinforcement learning process.

In a possible implementation, the terminal device may obtain a latest reward value of a reward item that is obtained after the target NPC releases the target skill at the next moment and moves in the target direction by the target distance. The target skill may be an attack skill. After moving to the east by a distance of 20 at the next moment, the target NPC releases skill A to attack the opponent. After moving to the east by the distance of 20 and releasing skill A to attack the opponent, the target NPC obtains the latest reward value. In another possible implementation, the terminal device may obtain a latest reward value of a reward item that is obtained after controlling the target NPC to release the target skill at the next moment. The target skill may be a healing skill. The target NPC releases the target skill at the next moment for the target NPC, and obtains the latest reward value after the skill is released.

The terminal device may make, in the manner of reinforcement learning based on the latest reward value, latest state information of the target NPC in the virtual scene, latest state information of the opponent of the target NPC, latest relative pose information of the target NPC and the opponent, and latest historical battle state information of the target NPC and the opponent, a decision about a battle policy that is to be taken by the target NPC at a target moment. The target moment is a moment after the next moment.

In a possible implementation, if the target NPC moves to the east by a distance of 20 at the next moment and then releases skill A to attack the opponent, the latest reward value of 20 may be obtained. After the target NPC moves to the east by the distance of 20 and releases skill A to attack the opponent, relative pose information of the target NPC and the opponent and state information of the opponent of the target NPC both change. The terminal device may make, in the manner of reinforcement learning, the decision on the battle policy that is to be taken by the target NPC at the target moment that is after the next moment.

In a possible implementation, the target NPC releases skill A at the next moment, i.e. a second moment, and moves towards the opponent by 5 along a straight line. After performing the above action, the target NPC obtains a reward value of 30. However, because the above action is performed, the target NPC stays in a sectoral range with a flame, and the reward value of the target NPC may be reduced by 10. At the second moment, the reward value is used as a criterion for evaluating the action of the target NPC. Based on the action at the second moment, an action performed by the target NPC at a third moment that is after the second moment may be obtained, and a reward value corresponding to the action performed at the third moment may be obtained. A decision about a battle policy that is to be taken by the target NPC at a next moment is made based on a cumulative reward value obtained at the second moment and the third moment.

When it is determined that the cumulative reward value of the reward item is maximum if the target NPC releases the target skill at the next moment and moves in the target direction by the target distance, the decision is made that the target NPC is to release the target skill at the next moment and move in the target direction by the target distance. In a possible implementation, the action that the target NPC releases skill A at the next moment, i.e. the second moment, and moves towards the opponent along the straight line by 5 maximizes the continuously cumulative value of the reward item of the target NPC. In this case, the action of releasing skill A and moving towards the opponent along the straight line by 5 is used as the battle policy of the target NPC.

When it is determined that the cumulative reward value of the reward item cannot be maximized if the target NPC releases the target skill at the next moment and moves in the target direction by the target distance, a skill, a movement direction, and a movement distance that maximize the reward item are determined through simulation as a skill that is to be released by the target NPC at the next moment, a direction in which the target NPC is to move, and a distance by which the target NPC is to move. In another possible implementation, if the action of moving towards the opponent along the straight line by 5 does not maximize the continuously cumulative value of the reward item of the target NPC, action II of releasing skill B and standing still and action III of releasing skill C and moving in a direction opposite to the opponent along the straight line by 6 are determined through simulation. Action III may maximize the reward item. The terminal device uses releasing skill C and moving in the direction opposite to the opponent along the straight line by 6 as the battle policy of the target NPC.

A reward value at each moment at which control over the target NPC to release a skill is completed is used as the latest reward value, to instruct the reinforcement learning to continue to make a decision about a battle policy at a next moment based on the reward value, so that the target NPC can be continuously controlled to interact with the opponent through the reinforcement learning, thereby ensuring continuity of control.

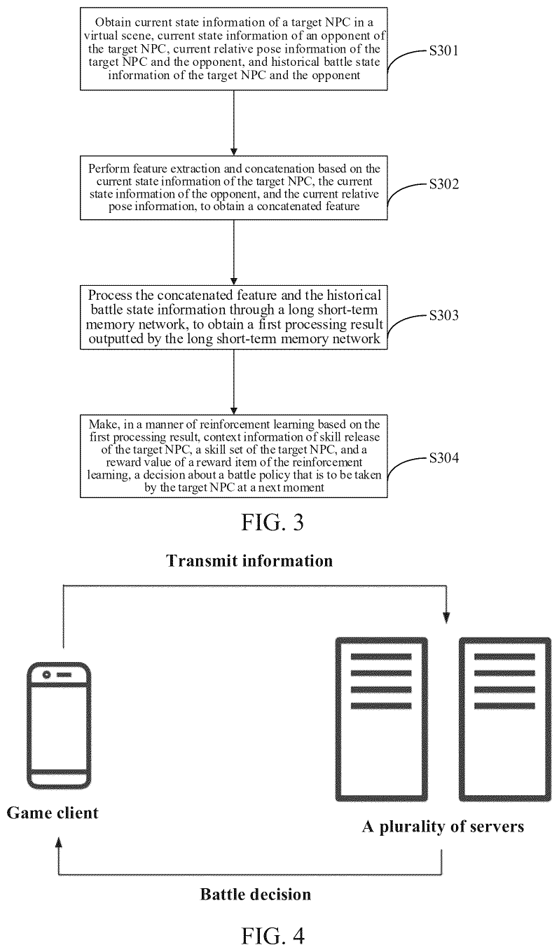

FIG. 4 is a schematic diagram of an application scene of a reinforcement-learning-based NPC battle decision-making method provided in an embodiment of this application. A game client herein exemplarily employs a smartphone. Certainly, in addition to the smartphone, the game client may further be a desktop computer, a tablet computer, a notebook computer, a palm computer, an in-vehicle terminal, or the like. The game client transmits information to a server. The game client transmits current state information of a target NPC, current state information of a opponent of the target NPC, current relative pose information of the target NPC and the opponent, and historical battle state information of the target NPC and the opponent to the server. The current state information of the target NPC includes information such as context information of skill release of the target NPC and a skill set of the target NPC. A plurality of servers obtains a battle decision of the target NPC through reinforcement learning, and return the battle decision to the game client.

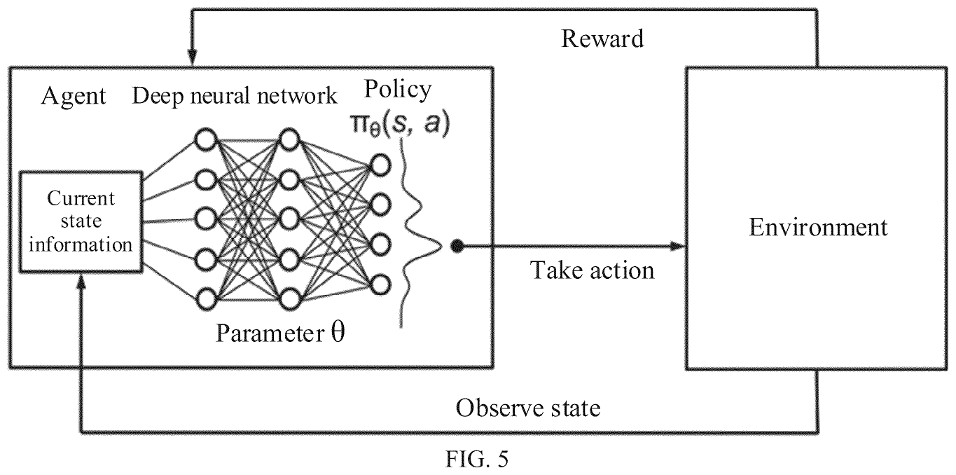

FIG. 5 is a schematic structural diagram of a reinforcement-learning-based NPC battle decision-making method provided in an embodiment of this application. Agent in FIG. 5 is a target NPC. State indicates current state information of the target NPC. Based on the current state information of the target NPC, a policy πθ (s, a) is obtained through a DNN, where parameter θ is a parameter of the DNN, and policy πθ (s, a) indicates an action of Agent. The action is outputted to Environment by Take action. Reward is determined based on impact of the action on Environment, and Observe state in Environment is returned to Agent. Agent outputs a next action based on returned Reward and Observe state.

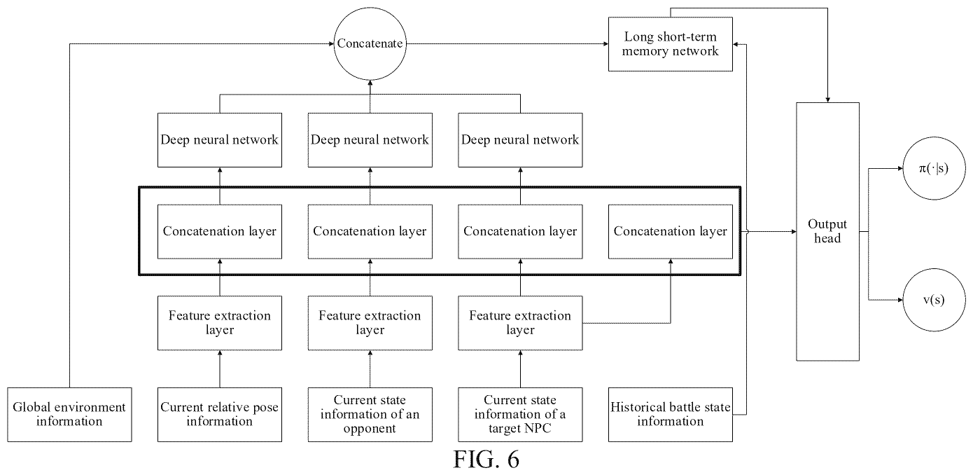

FIG. 6 is a diagram of a network structure of a reinforcement-learning-based NPC battle decision-making method provided this application. In FIG. 6, env_info in the lowest row represents global environment information; relative_info represents current relative pose information of a target NPC and an opponent; enemy_info represents current state information of the opponent of the target NPC; self_info represents current state information of the target NPC; and lstm_info represents historical battle state information of the target NPC and the opponent.

A feature corresponding to the current state information of the target NPC is obtained through a feature extraction layer self_layer based on the current state information self_info of the target NPC. The feature corresponding to the current state information of the target NPC is concatenated through a concatenation layer self_concat to obtain a long vector corresponding to the current state information of the target NPC. The long vector corresponding to the current state information of the target NPC is inputted to a first deep neural network (DNN) to obtain a first extraction result. Context information of skill release of the target NPC and a skill set of the target NPC in the current state information of the target NPC are inputted to the feature extraction layer self layer to obtain a skill-related feature. The skill-related feature is inputted to a concatenation layer skill_concat to and is concatenated through the concatenation layer skill_concat to obtain the long vector.

If the current state information of the target NPC includes current state information of a teammate NPC, a pooling layer Pooling can be added, to ensure dimension consistency of outputted features through the pooling layer Pooling.

A feature corresponding to the current state information of the opponent is obtained through a feature extraction layer enemy_layer based on information in the current state information enemy_layer of the opponent. The feature corresponding to the current state information of the opponent is inputted to a concatenation layer enemy_concat to obtain a long vector corresponding to current state information of the opponent. The long vector corresponding to current state information of the opponent is inputted to a second DNN to obtain a second extraction result.

A feature corresponding to the current relative pose information is obtained through a feature extraction layer relative_layer based on information in the current relative pose information relative_info of the target NPC and the opponent. The feature corresponding to the current relative pose information is inputted to a concatenation layer relative_concat to obtain a long vector corresponding to the relative pose information. The long vector corresponding to the relative pose information is inputted to a third DNN to obtain a third extraction result.

The global environment information, the first extraction result, the second extraction result, and the third extraction result are concatenated in a connection layer concat, to obtain a concatenated feature.

The concatenated feature and the historical battle state information lstm_info are processed through a long short-term memory network LSTM, to obtain a first processing result outputted by the long short-term memory network. A plurality of output heads Head are obtained in a manner of reinforcement learning based on the first processing result, the context information of skill release of the target NPC, the feature corresponding to the skill set of the target NPC, and a reward item of the reinforcement learning. The plurality of output heads Head may include an output head for releasing a skill, an output head for determining a direction, and an output head for determining a distance. Each output head uses a corresponding π (·|s) to represent a probability distribution corresponding to the output head. For example, the output head for releasing a skill corresponds to a first probability distribution of the target NPC about a released skill. The output head for determining a direction corresponds to a second probability distribution of the target NPC about a movement direction. The output head for determining a distance corresponds to a third probability distribution of the target NPC about a movement distance. Each output head further corresponds to a function value v(s), where v(s) is configured for evaluating quality of an action outputted by the output head, and the function value v(s) is related to a reward item. The output head for releasing a skill may use the long vector related to a skill outputted by the concatenation layer skill_concat, to ensure, through the concatenation layer skill_concat, that the output head for releasing a skill corresponds to a skill of the target NPC.

The network structure used in this application obtains an output of an action by inputting a state, and may represent a mapping relationship from a state to an action. Based on different input states, this application can use different network structures for processing. In a possible implementation, an input state feature is a continuous feature or a discrete feature, and a DNN may be used. In another possible implementation, an input feature is a two-dimensional planar grid structure, for example, a single-channel image for displaying a warning range before an opponent releases a skill. In this case, the single-channel image may be discretized into a grid and processed through a convolutional neural network (CNN).

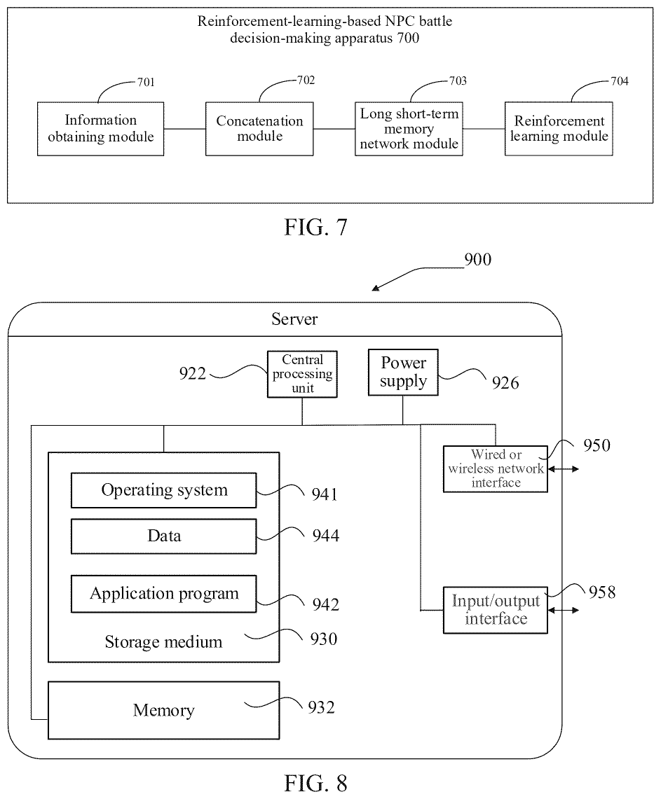

Based on the reinforcement-learning-based NPC battle decision-making method provided in the foregoing embodiment, this application further correspondingly provides a reinforcement-learning-based NPC battle decision-making apparatus 700. Descriptions are made below with reference to FIG. 7. FIG. 7 is a schematic structural diagram of a reinforcement-learning-based NPC battle decision-making apparatus provided in an embodiment of this application. The reinforcement-learning-based NPC battle decision-making apparatus shown in FIG. 7 includes:
an information obtaining module 701, configured to obtain current state information of a target NPC in a virtual scene, current state information of an opponent of the target NPC, current relative pose information of the target NPC and the opponent, and historical battle state information of the target NPC and the opponent, the current state information of the target NPC including context information of skill release of the target NPC and a skill set of the target NPC;
a concatenation module 702, configured to perform feature extraction and concatenation based on the current state information of the target NPC, the current state information of the opponent, and the current relative pose information, to obtain a concatenated feature;
a long short-term memory network module 703, configured to process the concatenated feature and the historical battle state information through a long short-term memory network, to obtain a first processing result outputted by the long short-term memory network; and
a reinforcement learning module 704, configured to make, in a manner of reinforcement learning based on the first processing result, the context information of the skill release of the target NPC, the skill set of the target NPC, and a reward item of the reinforcement learning, a decision about a battle policy that is to be taken by the target NPC at a next moment, the reward value of the reward item being determined based on reduction of a combat ability of the opponent.

In a possible implementation, the current state information of the target NPC further includes current combat ability attribute information and movement information of the target NPC. The current state information of the opponent includes current combat ability attribute information and movement information of the opponent, and the context information of the skill release of a combat object, i.e. the target NPC. The current relative pose information includes relative positions and relative orientations of the opponent and the target NPC.

The concatenation module is specifically configured to:
respectively perform feature extraction on the current state information of the target NPC, the current state information of the opponent, and the current relative pose information, to obtain a current state feature of the target NPC, a current state feature of the opponent, and a current relative pose feature of the target NPC and the opponent;
concatenate a plurality of features included in the current state feature of the target NPC, to obtain a first concatenation result;
concatenate a plurality of features included in the current state feature of the opponent, to obtain a second concatenation result;
concatenate a plurality of features included in the current relative pose feature, to obtain a third concatenation result;
respectively extract the features in the first concatenation result, the second concatenation result, and the third concatenation result by using a first deep neural network, a second deep neural network, and a third deep neural network, to obtain a first extraction result, a second extraction result, and a third extraction result; and
concatenate the first extraction result, the second extraction result, and the third extraction result, to obtain the concatenated feature.

In a possible implementation, the reinforcement-learning-based NPC battle decision-making apparatus further includes:
a global environment information obtaining module, configured to obtain global environment information of the target NPC in the virtual scene, the global environment information including time information, a quantity of opponents, and environment warning perception information, and the environment warning perception information including a warning range before the opponent releases a skill and a sustained effect after the opponent releases the skill.

The concatenation module is specifically configured to:
concatenate the global environment information, the first feature extraction result, the second feature extraction result, and the third feature extraction result, to obtain the concatenated feature.

In a possible implementation, the reinforcement learning module is specifically configured to:
perform feature extraction on the context information of the skill release of the target NPC and the skill set of the target NPC, to obtain a plurality of skill features of the target NPC, the skill set including a name, an effect label, cooldown time, a release distance, and current availability of each skill of the target NPC;
concatenate the plurality of skill features to obtain a skill feature concatenation result; and
make, in the manner of reinforcement learning based on the first processing result, the skill feature concatenation result, and the reward value of the reward item of the reinforcement learning, the decision about the battle policy that is to be taken by the target NPC at the next moment.

In a possible implementation, the reinforcement learning module is specifically configured to:
predict a first probability distribution, a second probability distribution, and a third probability distribution of the target NPC at the next moment based on the first processing result, the skill feature concatenation result, and a reward value of a reward item that is obtained by a battle policy taken at a previous moment, the first probability distribution being a probability distribution about a released skill, the second probability distribution being a probability distribution about a movement direction, and the third probability distribution being a probability distribution about a movement distance;
determine a target skill based on a highest value in the first probability distribution, determine a target direction based on a highest value in the second probability distribution, and determine a target distance based on a highest value in the third probability distribution;
control, if the target skill is an attack skill having a movement effect, the target NPC to release the target skill at the next moment and move in the target direction by the target distance; and
control, if the target skill is an attack skill having no movement effect or the target skill is a healing skill, the target NPC to release the target skill at the next moment.

The apparatus further includes a target moment battle policy determining module, configured to:
obtain a latest reward value of a reward item that is obtained after controlling the target NPC to release the target skill at the next moment and move in the target direction by the target distance, or obtain a latest reward value of a reward item that is obtained after controlling the target NPC to release the target skill at the next moment; and
make, in the manner of reinforcement learning based on the latest reward value, latest state information of the target NPC in the virtual scene, latest state information of the opponent of the target NPC, latest relative pose information of the target NPC and the opponent, and latest historical battle state information of the target NPC and the opponent, a decision about a battle policy that is to be taken by the target NPC at a target moment, the target moment being a moment after the next moment.

In a possible implementation, the reinforcement learning includes a plurality of reward items. The reinforcement learning module is further configured to: make, in the manner of reinforcement learning based on the first processing result, the context information of the skill release of the target NPC, the skill set of the target NPC, and weighted summation of respective reward values of the plurality of reward items, the decision about the battle policy that is to be taken by the target NPC at the next moment, and make, in the manner of reinforcement learning based on the first processing result, the context information of the skill release of the target NPC, the skill set of the target NPC, and the reward value of the reward item of the reinforcement learning, the decision about the battle policy that is to be taken by the target NPC at the next moment.

In a possible implementation, the current state information of the target NPC further includes current combat ability attribute information of a teammate belonging to a same camp as the target NPC, movement information, context information of a released skill of the teammate, and a skill set of the teammate.

An embodiment of this application provides a reinforcement-learning-based NPC battle decision-making device which may be a server. FIG. 8 is a schematic diagram of a structure of a server according to an embodiment of this application. The server 900 may vary greatly due to different configurations or performance, and may include one or more central processing units (CPUs) 922 (for example, one or more processors), a memory 932, and one or more storage media 930 (for example, one or more mass storage devices) that store application programs 942 or data 944. The memory 932 and the storage media 930 can achieve short-term storage or persistent storage. The program stored in the storage medium 930 may include one or more modules (not shown in the figure), and each module may include a series of instructions and operations in the server. Still further, the central processing unit 922 can be configured to communicate with the storage media 930 and perform the series of instructions and operations in the storage media 930 in the server 900.

The server 900 may further include one or more power supplies 926, one or more wired or wireless network interfaces 950, one or more input or output interfaces 958, one or more operating systems 941.

The CPU 922 is configured to perform the following operations:
obtaining current state information of a target NPC in a virtual scene, current state information of an opponent of the target NPC, current relative pose information of the target NPC and the opponent, and historical battle state information of the target NPC and the opponent, the current state information of the target NPC including context information of skill release of the target NPC and a skill set of the target NPC;
performing feature extraction and concatenation based on the current state information of the target NPC, the current state information of the opponent, and the current relative pose information, to obtain a concatenated feature;
processing the concatenated feature and the historical battle state information through a long short-term memory network, to obtain a first processing result outputted by the long short-term memory network; and
making, in a manner of reinforcement learning based on the first processing result, the context information of the skill release of the target NPC, the skill set of the target NPC, and a reward item of the reinforcement learning, a decision about a battle policy that is to be taken by the target NPC at a next moment, the reward value of the reward item being determined based on reduction of a combat ability of the opponent.

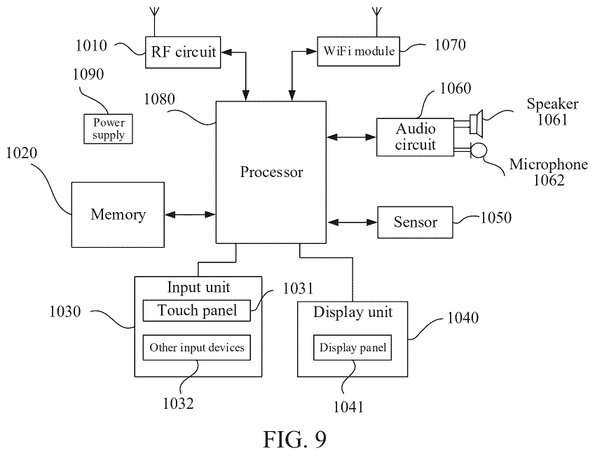

An embodiment of this application further provides another reinforcement-learning-based NPC battle decision-making device which may be a terminal device. As shown in FIG. 9, for ease of description, only a part related to this embodiment of this application is shown. For specific technical detail not disclosed, refer to the method part in the embodiments of this application. An example in which the terminal device is a mobile phone is used:

FIG. 9 IS a block diagram of some structures of a mobile phone according to an embodiment of this application. Referring to FIG. 9, the mobile phone includes components such as: a radio frequency (RF) circuit 1010, a memory 1020, an input unit 1030, a display unit 1040, a sensor 1050, an audio circuit 1060, a wireless fidelity (WiFi) module 1070, a processor 1080, and a power supply 1090. A person skilled in the art may understand that the structures, shown in FIG. 9, of the mobile phone do not constitute a limitation on the mobile phone, and the mobile phone may include more or fewer components than those shown in the figure, or a combination of some components, or a different component deployment may be used.

The following specifically describes the components of the mobile phone with reference to FIG. 9.

The RF circuit 1010 may be configured to receive and transmit a signal during an information receiving and sending process or a conversation process. Specifically, the RF circuit 1010 receives downlink information from a base station, then delivers the downlink information to the processor 1080 for processing, and transmits related uplink data to the base station. Generally, the RF circuit 1010 includes, but is not limited to, an antenna, at least one amplifier, a transceiver, a coupler, a low noise amplifier, a duplexer, and the like. In addition, the RF circuit 1010 may alternatively communicate with a network and another device by wireless communication. The wireless communication may use any communications standard or protocol, which includes, but is not limited to, a global system of mobile communication (GSM), a general packet radio service (GPRS), code division multiple access (CDMA), wideband code division multiple access (WCDMA), long term evolution (LTE), an email, a short messaging service (SMS), and the like.

The memory 1020 may be configured to store software programs and modules. The processor 1080 runs the software programs and the modules that are stored in the memory 1020, so as to implement various functional applications and data processing of the mobile phone. The memory 1020 may mainly include a program storage region and a data storage region. The program storage region may store an operating system and an application program required by at least one function (such as a sound playback function and an image playback function). The data storage region may store data created based on use of the mobile phone. In addition, the memory 1020 may include a high speed random access memory, and may further include a non-volatile memory, such as at least one magnetic disk storage device, a flash memory, or another volatile solid storage device.

The input unit 1030 may be configured to: receive input numeric or character information and generate signal inputs related to user settings and function control of the mobile phone. Specifically, the input unit 1030 may include a touch panel 1031 and another input device 1032. The touch panel 1031, which may alternatively be referred to as a touchscreen, may collect a touch operation of a user on or near the touch panel 1031 (such as an operation of a user on or near the touch panel 1031 by using any suitable object or accessory such as a finger or a stylus), and drive a corresponding connection apparatus according to a preset program. In some embodiments, the touch panel 1031 may include two parts: a touch detection apparatus and a touch controller. The touch detection apparatus detects a touch orientation of the user, detects a signal generated by the touch operation, and transmits the signal to the touch controller. The touch controller receives the touch information from the touch detection apparatus, converts the touch information into touch point coordinates, transmits the touch point coordinates to the processor 1080, and may receive and execute a command transmitted from the processor 1080. In addition, the touch panel 1031 may be a resistive, capacitive, infrared, or surface sound wave type touch panel. In addition to the touch panel 1031, the input unit 1030 may further include the another input device 1032. Specifically, the another input device 1032 may include, but is not limited to, one or more of a physical keyboard, a functional key (such as a volume control key or a switch key), a track ball, a mouse, and a joystick.

The display unit 1040 may be configured to display information inputted by a user or information provided for the user, and various menus of the mobile phone. The display unit 1040 may include a display panel 1041. In some embodiments, the display panel 1041 may be configured by using a liquid crystal display (LCD), an organic light-emitting diode (OLED), and the like. Further, the touch panel 1031 may cover the display panel 1041. After detecting a touch operation on or near the touch panel 1031, the touch panel 1031 transmits the touch operation to the processor 1080, to determine a type of a touch event. Then, the processor 1080 provides a corresponding visual output on the display panel 1041 based on the type of the touch event. Although in FIG. 9, the touch panel 1031 and the display panel 1041 are used as two separate components to implement input and input functions of the mobile phone, in some embodiments, the touch panel 1031 and the display panel 1041 may be integrated to implement the input and output functions of the mobile phone.

The mobile phone may further include at least one sensor 1050, such as an optical sensor, a motion sensor, and other sensors. Specifically, the optical sensor may include an ambient light sensor and a proximity sensor. The ambient light sensor may adjust luminance of the display panel 1041 based on brightness of the ambient light. The proximity sensor may switch off the display panel 1041 and/or backlight when the mobile phone is moved to an ear. As one type of motion sensor, an accelerometer sensor may detect magnitudes of accelerations in various directions (which generally are three axes), may detect a magnitude and a direction of the gravity when static, and may be applied to applications of identifying a posture of the mobile phone (such as switchover between a horizontal screen and a vertical screen, a related game, and posture calibration of a magnetometer), and a vibration identification-related function (such as a pedometer and knock). Other sensors, such as a gyroscope, a barometer, a hygrometer, a thermometer, and an infrared sensor, may be further configured in the mobile phone, which are not further described in detail here.

The audio circuit 1060, a speaker 1061, and a microphone 1062 may provide audio interfaces between the user and the mobile phone. The audio circuit 1060 may transmit an electrical signal converted from the received audio data to the speaker 1061. The speaker 1061 converts the electrical signal into a sound signal and outputs the sound signal. In another aspect, the microphone 1062 converts the received sound signal into an electrical signal. The audio circuit 1060 converts the received electrical signal into audio data and outputs the audio data to the processor 1080 for processing, and then the audio data is transmitted to, for example, another mobile phone via the RF circuit 1010, or is outputted to the memory 1020 for further processing.

WiFi is a short-distance wireless transmission technology. The mobile phone may help, through the WiFi module 1070, the user to receive and transmit an email, browse a web page, access stream media, and the like. This provides the user with wireless broadband Internet access. Although FIG. 9 shows the WiFi module 1070, the WiFi module is not a necessary component of the mobile phone. When required, the WiFi module may be omitted as long as the scope of the essence of this application is not changed.

The processor 1080 is a control center of the mobile phone, and connects to parts of the mobile phone by using various interfaces and lines. By running or executing the software programs and/or modules stored in the memory 1020, and invoking data stored in the memory 1020, the processor 1080 performs various functions and data processing of the mobile phone, thereby performing overall data and information acquisition on the mobile phone. In some embodiments, the processor 1080 may include one or more processing units. Preferably, the processor 1080 may integrate an application processor and a modem. The application processor mainly processes an operating system, a user interface, an application program, and the like. The modem mainly processes wireless communication. The modem may not be integrated into the processor 1080.

The mobile phone further includes a power supply 1090 (such as a battery) for supplying power to the components. Preferably, the power supply may be logically connected to the processor 1080 through a power management system, thereby implementing functions such as charging, discharging, and power consumption management through the power management system.

Although not shown in the figure, the mobile phone may further include a camera, a Bluetooth module, and the like, which are not further elaborated here.

In this embodiment of this application, the processor 1080 included in the mobile phone further has the following functions:
obtaining current state information of a target NPC in a virtual scene, current state information of an opponent of the target NPC, current relative pose information of the target NPC and the opponent, and historical battle state information of the target NPC and the opponent, the current state information of the target NPC including context information of skill release of the target NPC and a skill set of the target NPC;
performing feature extraction and concatenation based on the current state information of the target NPC, the current state information of the opponent, and the current relative pose information, to obtain a concatenated feature;
processing the concatenated feature and the historical battle state information through a long short-term memory network, to obtain a first processing result outputted by the long short-term memory network; and
making, in a manner of reinforcement learning based on the first processing result, the context information of the skill release of the target NPC, the skill set of the target NPC, and a reward item of the reinforcement learning, a decision about a battle policy that is to be taken by the target NPC at a next moment, the reward value of the reward item being determined based on reduction of a combat ability of the opponent.

An embodiment of this application further provides a non-transitory computer-readable storage medium, configured to store a computer program. When the computer program is run on a reinforcement-learning-based NPC battle decision-making device, the reinforcement-learning-based NPC battle decision-making device is configured to perform any implementation of the reinforcement-learning-based NPC battle decision-making method of the foregoing embodiments.

An embodiment of this application further provides a computer program product including a computer program. When the computer program product is run on the reinforcement-learning-based NPC battle decision-making device, the reinforcement-learning-based NPC battle decision-making device performs any implementation of the reinforcement-learning-based NPC battle decision-making method of the foregoing embodiments.

A person skilled in the art can clearly understand that for convenience and conciseness of description, specific working processes of the system and device described above can be found in the corresponding processes in the aforementioned method embodiments, and will not be elaborated here.

In the several embodiments provided in this application, the disclosed system and method are achieved in other manners. For example, the system embodiments described above are merely exemplary. For example, division of the system is merely logical function division and may be other division in actual implementation. For example, a plurality of systems may be combined or integrated into another system, or some features may be ignored or not performed. In addition, the shown or discussed mutual coupling or direct coupling or communication connection is an indirect coupling or communication connection through some interfaces, apparatuses or units, and is in an electrical, mechanical or another form.

The systems described as separate components may or may not be physically separated, and the components displayed as units may or may not be physical units, and may be located in one place or may be distributed over a plurality of network units. Some or all of the units are selected according to actual needs to achieve the objective of the solution of this embodiment.

In addition, functional units in the embodiments of this application may be integrated into one processing unit, or each of the units may exist alone physically, or two or more units are integrated into one unit. The integrated units mentioned above can be implemented in both a hardware form and a software functional unit form.

When the integrated unit is implemented in the form of a software functional unit and sold or used as an independent product, the integrated unit may be stored in a non-transitory computer-readable storage medium. Based on such an understanding, the technical solutions of this application essentially, or the part contributing to the related technology, or all or some of the technical solutions may be implemented in the form of a software product. The computer software product is stored in a storage medium and includes several instructions for instructing a computer device (which may be a personal computer, a server, a network device, or the like) to perform all or some of the operations of the methods described in the embodiments of this application. The foregoing storage media include: various media that can store computer programs, such as a USB flash drive, a mobile hard disk drive, a read-only memory (ROM), a random access memory (RAM), a magnetic disk, or a compact disc.

The foregoing embodiments are merely intended to describe the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to partial technical features thereof. However, these modifications or replacements do not make the essence of the corresponding technical solutions depart from the spirit and scope of the technical solutions of the various embodiments of this application.

What is claimed is:

1. A reinforcement-learning-based non-player character (NPC) battle decision-making method performed by a computer device, the method comprising:
obtaining current state information of a target NPC and an opponent of the target NPC, current relative pose information of the target NPC and the opponent in a virtual scene, and historical battle state information of the target NPC and the opponent;
performing feature extraction and concatenation on the current state information of the target NPC and the opponent and the current relative pose information of the target NPC and the opponent, to obtain a concatenated feature;
processing the concatenated feature and the historical battle state information through a long short-term memory network, to obtain a first processing result;
applying the first processing result, context information of the skill release of the target NPC and a skill set of the target NPC to a reinforcement learning model to obtain a reward value of a reward item based on reduction of a combat ability of the opponent; and
making a decision about a battle policy that is to be taken by the target NPC at a next moment based on the reward value of the reward item.

2. The method according to claim 1, wherein the performing feature extraction and concatenation on the current state information of the target NPC and the opponent and the current relative pose information of the target NPC and the opponent, to obtain a concatenated feature comprises:
respectively performing feature extraction on the current state information of the target NPC and the opponent, and the current relative pose information of the target NPC and the opponent, to obtain a current state feature of the target NPC, a current state feature of the opponent, and a current relative pose feature of the target NPC and the opponent;
concatenating a plurality of features comprised in the current state feature of the target NPC, to obtain a first concatenation result;
concatenating a plurality of features comprised in the current state feature of the opponent, to obtain a second concatenation result;
concatenating a plurality of features comprised in the current relative pose feature, to obtain a third concatenation result;
respectively extracting the features in the first concatenation result, the second concatenation result, and the third concatenation result by using a first deep neural network, a second deep neural network, and a third deep neural network, to obtain a first extraction result, a second extraction result, and a third extraction result; and
concatenating the first extraction result, the second extraction result, and the third extraction result, to obtain the concatenated feature.

3. The method according to claim 2, wherein the method further comprises:
obtaining global environment information of the target NPC in the virtual scene, the global environment information comprising time information, a quantity of opponents, and environment warning perception information, the environment warning perception information comprising a warning range before the opponent releases a skill and a sustained effect after the opponent releases the skill; and
concatenating the global environment information, the first feature extraction result, the second feature extraction result, and the third feature extraction result, to obtain the concatenated feature.

4. The method according to claim 1, wherein the making a decision about a battle policy that is to be taken by the target NPC at a next moment based on the reward value of the reward item comprises:
performing feature extraction on the context information of the skill release of the target NPC and the skill set of the target NPC, to obtain a plurality of skill features of the target NPC, the skill set comprising a name, an effect label, cooldown time, a release distance, and current availability of each skill of the target NPC;
concatenating the plurality of skill features to obtain a skill feature concatenation result; and
making the decision about the battle policy that is to be taken by the target NPC at the next moment based on the first processing result, the skill feature concatenation result, and the reward value of the reward item.

5. The method according to claim 4, wherein the making the decision about the battle policy that is to be taken by the target NPC at the next moment based on the first processing result, the skill feature concatenation result, and the reward value of the reward item comprises:
predicting a first probability distribution, a second probability distribution, and a third probability distribution of the target NPC at the next moment based on the first processing result, the skill feature concatenation result, and a reward value of a reward item that is obtained by a battle policy taken at a previous moment, the first probability distribution being a probability distribution about a released skill, the second probability distribution being a probability distribution about a movement direction, and the third probability distribution being a probability distribution about a movement distance;
determining a target skill based on a highest value in the first probability distribution, determining a target direction based on a highest value in the second probability distribution, and determining a target distance based on a highest value in the third probability distribution;
controlling, if the target skill is an attack skill having a movement effect, the target NPC to release the target skill at the next moment and move in the target direction by the target distance; and
controlling, if the target skill is an attack skill having no movement effect or the target skill is a healing skill, the target NPC to release the target skill at the next moment.

6. The method according to claim 1, wherein the reinforcement learning model comprises a plurality of reward items, and the making a decision about a battle policy that is to be taken by the target NPC at a next moment based on the reward value of the reward item comprises:
making the decision about the battle policy that is to be taken by the target NPC at the next moment based on the first processing result, the context information of the skill release of the target NPC, the skill set of the target NPC, and weighted summation of respective reward values of the plurality of reward items; and
making the decision about the battle policy that is to be taken by the target NPC at the next moment based on the first processing result, the context information of the skill release of the target NPC, the skill set of the target NPC, and the reward value of the reward item of the reinforcement learning.

7. The method according to claim 1, wherein the current state information of the target NPC further comprises current combat ability attribute information of a teammate belonging to a same camp as the target NPC, movement information, context information of a released skill of the teammate, and a skill set of the teammate.

8. The method according to claim 1, wherein the skill set of the target NPC comprises a name, an effect label, cooldown time, a release distance, and current availability of each skill of the target NPC.

9. A computer device comprising a processor and a memory,
the memory being configured to: store a computer program and transmit the computer program to the processor; and
the processor being configured to perform a reinforcement-learning-based NPC battle decision-making method including:
obtaining current state information of a target NPC and an opponent of the target NPC, current relative pose information of the target NPC and the opponent in a virtual scene, and historical battle state information of the target NPC and the opponent;
performing feature extraction and concatenation on the current state information of the target NPC and the opponent and the current relative pose information of the target NPC and the opponent, to obtain a concatenated feature;
processing the concatenated feature and the historical battle state information through a long short-term memory network, to obtain a first processing result;
applying the first processing result, context information of the skill release of the target NPC and a skill set of the target NPC to a reinforcement learning model to obtain a reward value of a reward item based on reduction of a combat ability of the opponent; and
making a decision about a battle policy that is to be taken by the target NPC at a next moment based on the reward value of the reward item.

10. The computer device according to claim 9, wherein the performing feature extraction and concatenation on the current state information of the target NPC and the opponent and the current relative pose information of the target NPC and the opponent, to obtain a concatenated feature comprises:
respectively performing feature extraction on the current state information of the target NPC and the opponent, and the current relative pose information of the target NPC and the opponent, to obtain a current state feature of the target NPC, a current state feature of the opponent, and a current relative pose feature of the target NPC and the opponent;
concatenating a plurality of features comprised in the current state feature of the target NPC, to obtain a first concatenation result;
concatenating a plurality of features comprised in the current state feature of the opponent, to obtain a second concatenation result;
concatenating a plurality of features comprised in the current relative pose feature, to obtain a third concatenation result;
respectively extracting the features in the first concatenation result, the second concatenation result, and the third concatenation result by using a first deep neural network, a second deep neural network, and a third deep neural network, to obtain a first extraction result, a second extraction result, and a third extraction result; and
concatenating the first extraction result, the second extraction result, and the third extraction result, to obtain the concatenated feature.

11. The method according to claim 10, wherein the method further comprises:
obtaining global environment information of the target NPC in the virtual scene, the global environment information comprising time information, a quantity of opponents, and environment warning perception information, the environment warning perception information comprising a warning range before the opponent releases a skill and a sustained effect after the opponent releases the skill; and
concatenating the global environment information, the first feature extraction result, the second feature extraction result, and the third feature extraction result, to obtain the concatenated feature.

12. The computer device according to claim 9, wherein the making a decision about a battle policy that is to be taken by the target NPC at a next moment based on the reward value of the reward item comprises:
performing feature extraction on the context information of the skill release of the target NPC and the skill set of the target NPC, to obtain a plurality of skill features of the target NPC, the skill set comprising a name, an effect label, cooldown time, a release distance, and current availability of each skill of the target NPC;
concatenating the plurality of skill features to obtain a skill feature concatenation result; and
making the decision about the battle policy that is to be taken by the target NPC at the next moment based on the first processing result, the skill feature concatenation result, and the reward value of the reward item.

13. The computer device according to claim 9, wherein the reinforcement learning model comprises a plurality of reward items, and the making a decision about a battle policy that is to be taken by the target NPC at a next moment based on the reward value of the reward item comprises:
making the decision about the battle policy that is to be taken by the target NPC at the next moment based on the first processing result, the context information of the skill release of the target NPC, the skill set of the target NPC, and weighted summation of respective reward values of the plurality of reward items; and
making the decision about the battle policy that is to be taken by the target NPC at the next moment based on the first processing result, the context information of the skill release of the target NPC, the skill set of the target NPC, and the reward value of the reward item of the reinforcement learning.

14. The computer device according to claim 9, wherein the current state information of the target NPC further comprises current combat ability attribute information of a teammate belonging to a same camp as the target NPC, movement information, context information of a released skill of the teammate, and a skill set of the teammate.

15. The computer device according to claim 9, wherein the skill set of the target NPC comprises a name, an effect label, cooldown time, a release distance, and current availability of each skill of the target NPC.

16. A non-transitory computer-readable storage medium, having a computer program stored therein, the computer program, when executed by a processor of a computer device, causing the computer device to implement a reinforcement-learning-based NPC battle decision-making method including:
obtaining current state information of a target NPC and an opponent of the target NPC, current relative pose information of the target NPC and the opponent in a virtual scene, and historical battle state information of the target NPC and the opponent;
performing feature extraction and concatenation on the current state information of the target NPC and the opponent and the current relative pose information of the target NPC and the opponent, to obtain a concatenated feature;
processing the concatenated feature and the historical battle state information through a long short-term memory network, to obtain a first processing result;
applying the first processing result, context information of the skill release of the target NPC and a skill set of the target NPC to a reinforcement learning model to obtain a reward value of a reward item based on reduction of a combat ability of the opponent; and
making a decision about a battle policy that is to be taken by the target NPC at a next moment based on the reward value of the reward item.

17. The non-transitory computer-readable storage medium according to claim 16, wherein the performing feature extraction and concatenation on the current state information of the target NPC and the opponent and the current relative pose information of the target NPC and the opponent, to obtain a concatenated feature comprises:
respectively performing feature extraction on the current state information of the target NPC and the opponent, and the current relative pose information of the target NPC and the opponent, to obtain a current state feature of the target NPC, a current state feature of the opponent, and a current relative pose feature of the target NPC and the opponent;
concatenating a plurality of features comprised in the current state feature of the target NPC, to obtain a first concatenation result;
concatenating a plurality of features comprised in the current state feature of the opponent, to obtain a second concatenation result;
concatenating a plurality of features comprised in the current relative pose feature, to obtain a third concatenation result;
respectively extracting the features in the first concatenation result, the second concatenation result, and the third concatenation result by using a first deep neural network, a second deep neural network, and a third deep neural network, to obtain a first extraction result, a second extraction result, and a third extraction result; and
concatenating the first extraction result, the second extraction result, and the third extraction result, to obtain the concatenated feature.

18. The non-transitory computer-readable storage medium according to claim 17, wherein the method further comprises:
obtaining global environment information of the target NPC in the virtual scene, the global environment information comprising time information, a quantity of opponents, and environment warning perception information, the environment warning perception information comprising a warning range before the opponent releases a skill and a sustained effect after the opponent releases the skill; and
concatenating the global environment information, the first feature extraction result, the second feature extraction result, and the third feature extraction result, to obtain the concatenated feature.

19. The non-transitory computer-readable storage medium according to claim 16, wherein the making a decision about a battle policy that is to be taken by the target NPC at a next moment based on the reward value of the reward item comprises:
performing feature extraction on the context information of the skill release of the target NPC and the skill set of the target NPC, to obtain a plurality of skill features of the target NPC, the skill set comprising a name, an effect label, cooldown time, a release distance, and current availability of each skill of the target NPC;
concatenating the plurality of skill features to obtain a skill feature concatenation result; and
making the decision about the battle policy that is to be taken by the target NPC at the next moment based on the first processing result, the skill feature concatenation result, and the reward value of the reward item.

20. The non-transitory computer-readable storage medium according to claim 16, wherein the current state information of the target NPC further comprises current combat ability attribute information of a teammate belonging to a same camp as the target NPC, movement information, context information of a released skill of the teammate, and a skill set of the teammate.
